(19) United States
(12) Patent Application Publication
(10) Pub. No.: US 2007/0083365 A1
(43) Pub. Date: Apr. 12, 2007

(54) Neural network classifier for separating audio sources from a monophonic audio signal

(75) Inventor: Dmitri V. Shmunk, Novosibirsk (RU)

Correspondence Address: DTS, INC., 5171 CLARETON DRIVE, AGOURA HILLS, CA, 91301, US

(73) Assignee: DTS, Inc.

(21) Appl. No.: 11/244,554

(22) Filed: Oct. 6, 2005

(51) Int. Cl. G10L 15/16

(52) U.S. Cl. 704/232

(57) ABSTRACT

A neural network classifier provides the ability to separate and categorize multiple arbitrary and previously unknown audio sources down-mixed to a single monophonic audio signal. This is accomplished by breaking the monophonic audio signal into baseline frames (possibly overlapping), windowing the frames, extracting a number of descriptive features in each frame, and employing a pre-trained nonlinear neural network as a classifier. Each neural network output manifests the presence of a pre-determined type of audio source in each baseline frame of the monophonic audio signal. The neural network classifier is well suited to address widely changing parameters of the signal and sources, time and frequency domain overlapping of the sources, and reverberation and occlusions in real-life signals. The classifier outputs can be used as a front-end to create multiple audio channels for a source separation algorithm (e.g., ICA) or as parameters in a post-processing algorithm (e.g. categorize music, track sources, generate audio indexes for the purposes of navigation, re-mixing, security and surveillance, telephone and wireless communications, and teleconferencing).

### BACKGROUND OF THE INVENTION

1. Field of the Invention

This invention relates to the separation of multiple unknown audio sources down-mixed to a single monophonic audio signal.

2. Description of the Related Art

Techniques exist for extracting source from either stereo or multichannel audio signals. Independent component analysis (ICA) is the most widely-known and researched method. However, ICA can only extract a number of sources equal to or less then number of channels in the input signal. Therefore it can not be used in monophonic signal separation.

Extraction of audio sources from a monophonic signal can be useful to extract speech signal characteristics, synthesize a multichannel signal representation, categorize music, track sources, generate an additional channel for ICA, generate audio indexes for the purposes of navigation (browsing), re-mixing (consumer & pro), security and surveillance, telephone and wireless comm, and teleconferencing. The extraction of speech signal characteristics (like automated dictor detection, automated speech recognition, speech/music detectors) is well developed. Extraction of arbitrary musical instrument information from monophonic signal is very sparsely researched due to the difficulties posed by the problem, which include widely changing parameters of the signal and sources, time and frequency domain overlapping of the sources, and reverberation and occlusions in real-life signals. Known techniques include equalization and direct parameter extraction.

An equalizer can be applied to the signal to extract sources that occupy known frequency range. For example, most energy of the speech signal is present in the 200 Hz-4 kHz range. Bass guitar sounds are normally limited to the frequencies below 1 kHz. By filtering all the out-of-band signal, the selected source can be either extracted, or it's energy can be amplified relating to other sources. However, equalization is not effective for extracting overlapping sources.

One method of direct parameter extraction is described in ‘Audio Content Analysis for Online Audiovisual Data Segmentation and Classification’ by Tong Zhang and Jay Kuo (IEEE Transactions on speech and audio processing, vol.9 No.4, May 2001). Simple audio features such as energy function, the average zero-crossing rate, the fundamental frequency, and the spectral peak tracks are extracted. The signal is then divided into categories (silence; with music components; without music components) and subcategories. An inclusion of a fragment into certain category is decided upon direct comparison of a feature to a set of limits. A priori knowledge of the sources is required.

A method of musical genre categorization is described in ‘Musical Genre Classification of Audio Signals’ by George Tzanetakis and Perry Cook (IEEE Transactions on speech and audio processing, vol.10 No.5, July 2002). Features like instrumentation, rhytmic structure, and harmonic content are extracted from the signal and input in a pre-trained statistical pattern recognition classifier. ‘Acoustic Segmentation for Audio Browsers’ by Don Kimbler and Lynn Wilcox employ Hidden Markov Models for the audio segmentation and classification.

### SUMMARY OF THE INVENTION

The present invention provides the ability to separate and categorize multiple arbitrary and previously unknown audio sources down-mixed to a single monophonic audio signal.

This is accomplished by breaking the monophonic audio signal into baseline frames (possibly overlapping), windowing the frames, extracting a number of descriptive features in each frame, and employing a pre-trained nonlinear neural network as a classifier. Each neural network output manifests the presence of a pre-determined type of audio source in each baseline frame of the monophonic audio signal. The neural network typically has as many outputs as there are types of audio sources the system is trained to discriminate. The neural network classifier is well suited to address widely changing parameters of the signal and sources, time and frequency domain overlapping of the sources, and reverberation and occlusions in real-life signals. The classifier outputs can be used as a front-end to create multiple audio channels for a source separation algorithm (e.g., ICA) or as parameters in a post-processing algorithm (e.g. categorize music, track sources, generate audio indexes for the purposes of navigation, re-mixing, security and surveillance, telephone and wireless communications, and teleconferencing).

In a first embodiment, the monophonic audio signal is sub-band filtered. The number of sub-bands and the variation or uniformity of the sub-bands is application dependent. Each sub-band is then framed and features extracted. The same or different combinations of features may be extracted from the different sub-bands. Some sub-bands may have no features extracted. Each sub-band feature may form a separate input to the classifier or like features may be “fused” across the sub-bands. The classifier may include a single output node for each pre-determined audio source to improve the robustness of classifying each particular audio source. Alternately, the classifier may include an output node for each sub-band for each pre-determined audio source to improve the separation of multiple frequency-overlapped sources.

In a second embodiment, one or more of the features e.g. tonal components or TNR, is extracted at multiple time-frequency resolutions and then scaled to the baseline frame size. This is preferably done in parallel but can be done sequentially. The features at each resolution can be input to the classifier or they can be fused to form a single input. This multi-resolution approach addresses the non-stationarity of natural signals. Most signals can only be considered as a quasi-stationary at short time intervals. Some signals change faster, some slower, e.g. for speech, with fast varying signal parameters, shorter time-frames will result in a better separation of the signal energy. For string instruments that are more stationary, longer frames provide higher frequency resolution without decrease in signal energy separation.

In a third embodiment, the monophonic audio signal is sub-band filtered and one or more of the features in one or more sub-bands is extracted at multiple time-frequency resolutions and then scaled to the baseline frame size. The combination of sub-band filter and multi-resolution may further enhance the capability of the classifier.

In a fourth embodiment, the values at the Neural Net output nodes are low-pass filtered to reduce the noise, hence frame-to-frame variation, of the classification. Without low-pass filtering, the system operates on a short pieces of the signal (baseline frames) without the knowledge of the past or future inputs. Low-pass filtering decreases the number of false results, assuming that a signal typically lasts for more then one baseline frame.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a block diagram for the separation of multiple unknown audio sources down-mixed to a single monophonic audio signal using a Neural Network classifier in accordance with the present invention;

FIG. 2 is a diagram illustrating sub-band filtering of the input signal;

FIG. 3 is a diagram illustrating the framing and windowing of the input signal;

FIG. 4 is a flowchart for extracting multi-resolution tonal components and TNR features;

FIG. 5 is a flowchart for estimating the noise floor;

FIG. 6 is a flowchart for extracting a Cepstrum peak feature;

FIG. 7 is a block diagram of a typical Neural Network classifier;

FIGS. 8a-8c are plots of the audio sources that makeup a monophonic signal and the measures output by the Neural Network classifier;

FIG. 9 is a block diagram of a system for using the output measures to remix the monophonic signal into a plurality of audio channels; and

FIG. 10 is a block diagram of a system for using the output measures to augment a standard post-processing task performed on the monophonic signal.

### DETAILED DESCRIPTION OF THE INVENTION

The present invention provides the ability to separate and categorize multiple arbitrary and previously unknown audio sources down-mixed to a single monophonic audio signal.

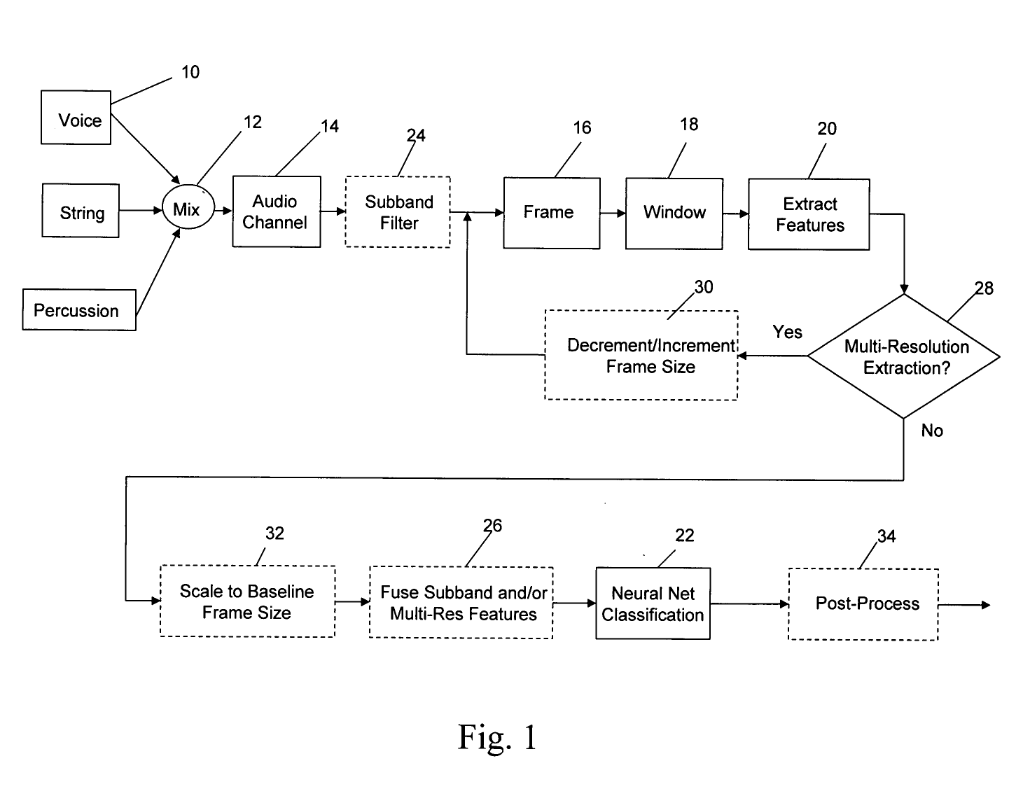

As shown in FIG. 1, a plurality of audio sources 10, e.g. voice, string, and percussion, have been down-mixed (step 12) to a single monophonic audio channel 14. The monophonic signal may be a conventional mono mix or it may be one channel of a stereo or multi-channel signal. In the most general case, there is no a priori information regarding the particular types of audio sources in the specific mix, the signals themselves, how many different signals are included, or the mixing coefficients. The types of audio sources which might be included in a specific mix are known. For example, the application may be to classify the sources or predominant sources in a music mix. The classifier will know that the possible sources include male vocal, female vocal, string, percussion etc. The classifier will not know which of these sources or how many are included in the specific mix, anything about the specific sources or how they were mixed.

The process of separating and categorizing the multiple arbitrary and previously unknown audio sources starts by framing the monophonic audio signal into a sequence of baseline frames (possibly overlapping) (step 16), windowing the frames (step 18), extracting a number of descriptive features in each frame (step 20), and employing a pre-trained nonlinear neural network as a classifier (step 22). Each neural network output manifests the presence of a pre-determined type of audio source in each baseline frame of the monophonic audio signal. The neural network typically has as many outputs as there are types of audio sources the system is trained to discriminate.

The performance of the Neural Network classifier, particularly in separating and classifying “overlapping sources” can be enhanced in a number of ways including sub-band filtering of the monophonic signal, extracting multi-resolution features and low-pass filtering the classification values.

In a first enhanced embodiment, the monophonic audio signal can be sub-band filtered (step 24). This is typically but not necessarily performed prior to framing. The number of sub-bands and the variation or uniformity of the sub-bands is application dependent. Each sub-band is then framed and features extracted. The same or different combinations of features may be extracted from the different sub-bands. Some sub-bands may have no features extracted. Each sub-band feature may form a separate input to the classifier or like features may be “fused” across the sub-bands (step 26). The classifier may include a single output node for each pre-determined audio source, in which case extracting features from multiple sub-bands improves the robustness of classifying each particular audio source. Alternately, the classifier may include an output node for each sub-band for each pre-determined audio source, in which case extracting features from multiple sub-bands improves the separation of multiple frequency-overlapped sources.

In a second enhanced embodiment, one or more of the features is extracted at multiple time-frequency resolutions and then scaled to the baseline frame size. As shown, the monophonic signal is initially segmented into baseline frames, windowed and the features extracted. If one or more of the features is being extracted at multiple resolutions (step 28), the frame size is decremented (incremented) (step 30) and the process is repeated. The frame size is suitably decremented (incremented) as a multiple of the baseline frame size adjusted for overlap and windowing. As a result, there will be multiple instances of each feature over the equivalent of a baseline frame. These features must then be scaled to the baseline frame size, either independently or together (step 32). Features extracted at smaller frame sizes are averaged and features extracted at larger frames sizes are interpolated to the baseline frame size. In some cases, the algorithm may extract multi-resolution features by both decrementing and incrementing from the baseline frame. Furthermore, it may be desirable to fuse the features extracted at each resolution to form one input to the classifier (step 26). If the multi-resolution features are not fused, the baseline scaling (step 32) can be performed inside the loop and the features input to the classifier at each pass. More preferably the multi-resolution extraction is performed in parallel.

In a third enhanced embodiment, the values at the Neural Net's output nodes are post-processed using, for example, a moving-average low-pass filter (step 34) to reduce the noise, hence frame-to-frame variation, of the classification.

Sub-band Filtering

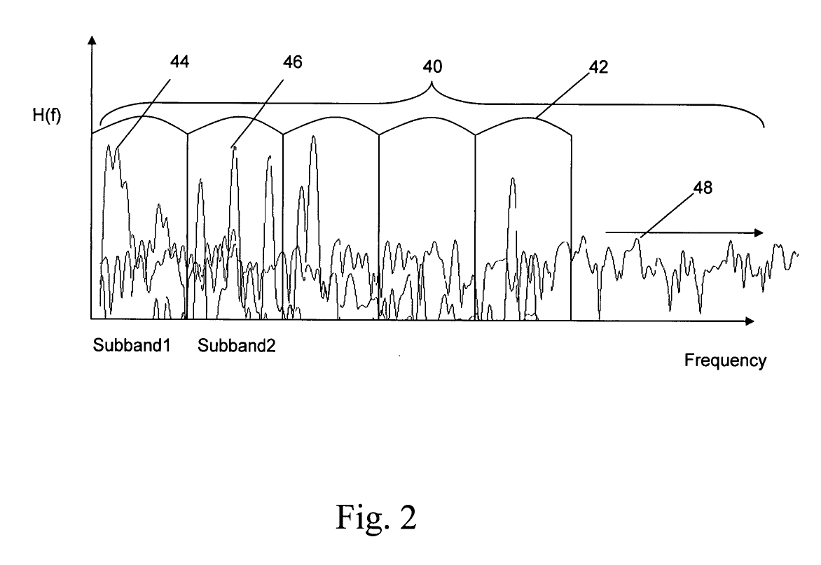

As shown in FIG. 2, a sub-band filter 40 divides the frequency spectra of the monophonic audio signal into N uniform or varying width sub-bands 42. For purposes of illustration possible frequency spectra H(f) are shown for voice 44, string 46 and percussion 48. By extracting features in sub-bands where the source overlap is low, the classifier may do a better job at classifying the predominant source in the frame. In addition, by extracting features in different sub-bands, the classifier may be able to classify the predominant source in each of the sub-bands. In those sub-bands where signal separation is good, the confidence of the classification may be very strong, e.g. near 1. Whereas in those sub-bands where the signals overlap, the classifier may be less confident that one source predominates, e.g. two or more sources may have similar output values.

The equivalent function can also be provided using a frequency transform in stead of the sub-band filter.

Framing & Windowing

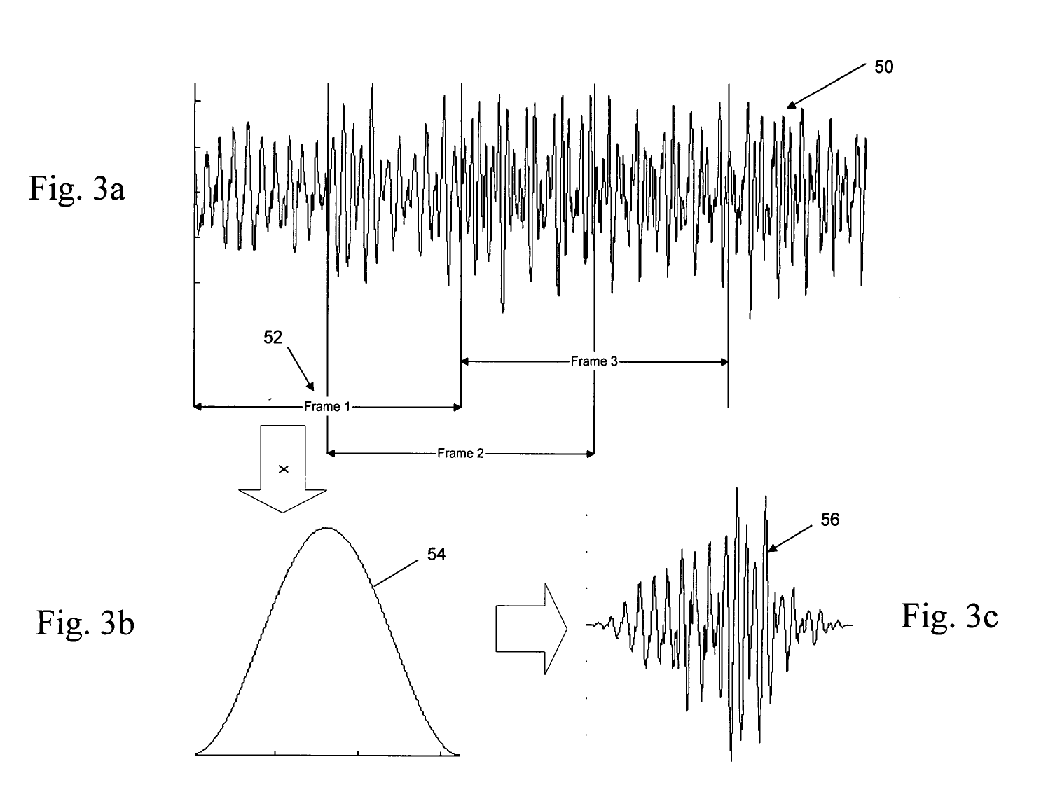

As shown in FIGS. 3a-3c, the monophonic signal 50 (or each sub-band of the signal) is broken into a sequence of baseline frames 52. The signal is suitably broken into overlapping frames and preferably with an overlap of 50% or greater. Each frame is windowed to reduce effects of discontinuities at frame boundaries and improve frequency separation. Well-known analysis windows 54 include Raised Cosine, Hamming, Hanning and Chebyschev, etc. The windowed signal 56 for each baseline frame is then passed on for feature extraction.

Feature Extraction

Feature extraction is the process of computing a compact numerical representation that can be used to characterize a baseline frame of audio. The idea is to identify a number of features, which alone or in combination with other features, at a single or multiple resolutions, and in a single or multiple spectral bands, effectively differentiate between different audio sources. Examples of the features that are useful in separation of sources from a monophonic audio signal include: total number of tonal components in a frame; Tone-to-Noise Ratio (TNR); and Cepstrum peak amplitude. In addition to these features, any one or combination of the 17 low-level descriptors for audio described in the MPEG-7 specification may be suitable features in different applications.

We will now describe the tonal components, TNR and Cepstrum peak features in detail. In addition, the tonal components and TNR features are extracted at multiple time-frequency resolutions and scaled to the baseline frame. The steps for calculating the “low-level descriptors” are available in the supporting documentation for MPEG-7 audio. (See for example, International Standard ISO/IEC 15938 “Multimedia Content Description Interface”, or http://www.chiariglione.org/mpeg/standards/mpeg-7/mpeg-7.htm)

Tonal Components

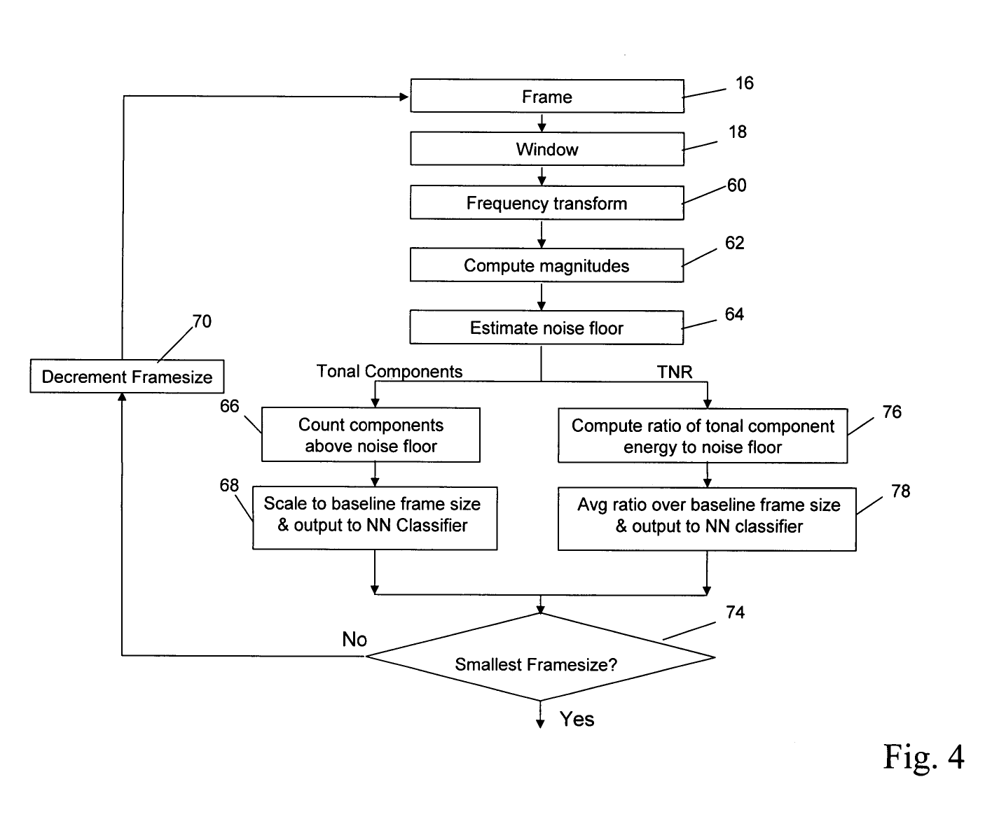

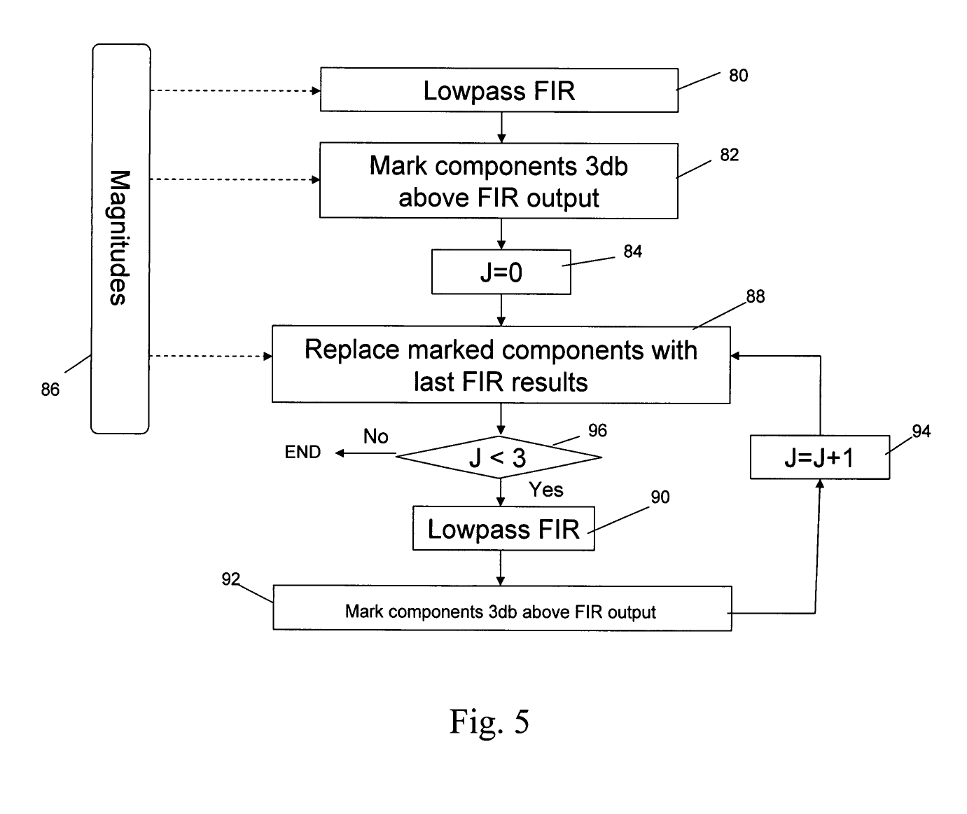

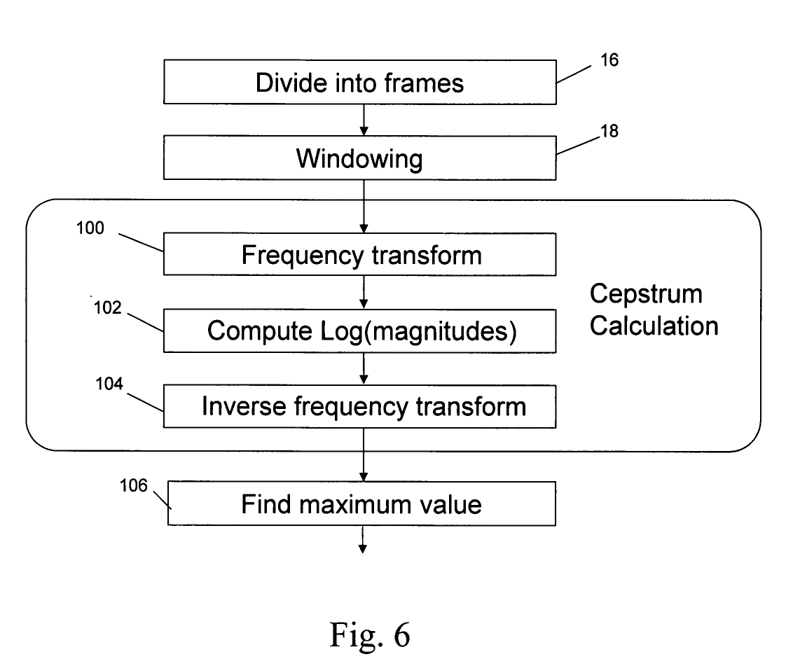

A Tonal Component is essentially a tone that is relatively strong as compared to the average signal. The feature that is extracted is the number of tonal components at a given time-frequency resolution. The procedure for estimating the number of tonal components at a single time-frequency resolution level in each frame is illustrated in FIG. 4 and includes the following steps:
1. Frame the monophonic input signal (step 16).
2. Window the data falling in the frame (step 18).
3. Apply frequency transform to the windowed signal (step 60), such as FFT, MDCT, etc. The length of the transform should equal the number of audio samples in the frame, i.e. the frame size. Enlarging transform length will lower time resolution, without enhancements in frequency resolution. Having smaller transform length then a length of a frame will lower frequency resolution.
4. Compute magnitude of the spectral lines (step 62). For a FFT, the magnitude A=Sqrt(Re*Re+Im*Im) where Re and Im are the Real and Imaginary components of a spectral line produced by the transform.
5. Estimate noise-floor level for all frequencies (step 64). (See FIG. 5)
6. Count number of components sufficiently above the noise floor e.g. more than a pre-defined fixed threshold above the noise floor (step 66). These components are considered ‘tonal components’ and the count is output to the NN classifier (step 68).

Real life audio signals can contain both stationary fragments with tonal components in them (like string instruments) and non-stationary fragments that also has tonal components in them (like voiced speech fragments). To efficiently capture tonal components in all situations the signal has to be analyzed at various time-frequency resolution levels. Practically useful results can be extracted in frames ranging approximately from 5 msec to 200 msec. Note, that these frames are preferably interleaving, and many frames of a given length can fall under a single baseline frame.

To estimate the number of tonal components at multiple time-frequency resolutions, the above procedure is modified as follows:
1. Decrement Frame Size, e.g. by a factor of 2 (ignoring overlapping) (step 70).
2. Repeat steps 16, 18, 60, 62, 64 and 66 for the new frame size. A frequency transform with the length equal to the length of frame should be performed to obtain optimal time-frequency tradeoff.
3. Scale the count of the tonal components to the baseline frame size and output to the NN classifier (step 72). As shown, a cumulative number of tonal components at each time-frequency resolution is individually passed to the classifier. In a simpler implementation, the number of tonal components at all of the resolutions would be extracted and summed together to form a single value.
4. Repeat until the smallest desired framesize has been analyzed (step 74).

To illustrate the extraction of multi-resolution tonal components consider the following example. The baseline framesize is 4096 samples. The tonal components are extracted at 1024, 2048 and 4096 transform lengths (non-overlapping for simplicity). Typical results might be:

At 4096-point transform: 5 components

At 2048-point transforms (total of 2 transforms in one baseline frame): 15 components, 7 components

At 1024-point transforms (total of 4 transforms in one baseline frame): 3, 10, 17, 4 The numbers that will be passed to the NN inputs will be 5, 22(=15+7), 34(=3+10+17+4) at each pass. Or alternately the values could be summed 61=5+22+34 and input as a single value.

The algorithm for computing multi time-frequency resolutions by incrementing is analogous.

Tone-to-Noise Ratio (TNR)

Tone-to-noise ratio is a measure of the ratio of the total energy in the tonal components to the noise floor also can be a very relevant feature for discrimination of various types of the sources. For example, various kinds of string instruments have different TNR levels. The process of tone-to-noise ratio is similar to the estimation of number of tonal components described above. Instead of counting the number of tonal components (step 66), the procedure computes the ratio of the cumulative energy in the tonal components to the noise floor (step 76) and outputs the ratio the NN classifier (step 78).

Measuring TNR at various time-frequency resolutions is also an advantage to provide a more robust performance with real-life signals. The framesize is decremented (step 70) and the procedure repeated for a number of small frame sizes. The results from the smaller frames are scaled by averaging them over a time period equal to the baseline frame (step 78). As with the tonal components, the averaged ratio can be output to the classifier at each pass or they can be summed to a single value. Also, the different resolutions for both tonal components and TNR are suitably calculated in parallel.

To illustrate the extraction of multi-resolution TNRs consider the following example. The baseline framesize is 4096 samples. The TNRs are extracted at 1024, 2048 and 4096 transform lengths (non-overlapping for simplicity). Typical results might be:

At 4096-point transform: ratio of 40 db

At 2048-point transforms (total of 2 transforms in one baseline frame): ratios of 28 db, 20 db

At 1024-point transforms (total of 4 transforms in one baseline frame): ratio of 20 db, 20 db, 16 db and 12 db

The ratios that will be passed to the NN inputs will be 40 db, 24 db and 17 db at each pass. Or alternately the values could be summed (average=27 db) and input as a single value.

The algorithm for computing multi time-frequency resolutions by incrementing is analogous.

Noise Floor Estimation

The noise floor used to estimate the tonal components and TNR is a measure of the ambient or unwanted portion of the signal. For instance, if we are attempting to classify or separate the musical instruments in a live acoustic musical performance, the noise floor would represent the average acoustic level of the room when the musicians are not playing.

A number of algorithms can be used to estimate noise floor in a frame. In one implementation a low-pass FIR filter can be applied over the amplitudes of the spectral lines. The result of such filtering will be slightly higher then the real noise floor since it includes both noisy and tonal components energy. This although, can be compensated for by lowering the threshold value. As shown in FIG. 5, a more precise algorithm refines the simple FIR filter approach to get closer to real noise floor.

A simple estimation of the noise floor is found by application of a FIR filter:

$${N}_{i} = {\sum }_{k = - \frac{L}{2}}^{\frac{L}{2}} {A}_{i + k} \cdot {C}_{k}$$

Where: Nᵢ—estimated noise floor for i^{th} spectral line;

Aᵢ—magnitudes of spectral lines after frequency transform;

Cₖ—FIR filter coefficients; and

L—length of the filter.

As shown in FIG. 5, the more precise estimation refines the initial lowpass FIR estimation (step 80) given above by marking components that lie sufficiently above noise floor, e.g. 3 dB above the FIR output at each frequency (step 82). Once marked, a counter is set, e.g. J=0 (step 84) and the marked components (magnitudes 86) are replaced with the last FIR results (step 88). This step effectively removes the tonal component energy from the calculation of the noise floor. The lowpass FIR is re-applied (step 90), the components that lie sufficiently above the noise floor are marked (step 92), the counter is increment (step 94) and the marked components are again replaced with the last FIR results (step 88). This process is repeated for a desired number of iterations, e.g. 3 (step 96). Higher number of iterations will result in slightly better precision.

It is worth noting that the Noise Floor estimation itself may be used as a feature to describe and separate the audio sources.

Cepstrum Peak

Cepstrum analysis is usually utilized in speech-processing related applications. Various characteristics of the cepstrum can be used as parameters for processing. Cepstrum is also descriptive for other types of highly-harmonic signals. A Cepstrum is the result of taking the inverse Fourier transform of the decibel spectrum as if it were a signal. The procedure of extraction of a Cepstrum Peak is as follows:
1. Separate the audio signal into a sequence of frames (step 16).
2. Window the signal in each frame (step 18).
4. Compute Cepstrum:
   a. Compute a frequency transform of the windowed signal, e.g. FFT (step 100);
   b. Compute log-amplitude of the spectral line magnitudes (step 102); and
   c. Compute the inverse transform on log-amplitudes (step 104).
5. The Cepstrum peak is the value and position of the maximum value in the cepstrum (step 106).
   Neural Network Classifier

Many known types of neural networks are suitable to operate as classifiers. The current state of art in neural network architectures and training algorithms makes a feedforward network (a layered network in which each layer only receives inputs from previous layers) a very good candidate. Existing training algorithms provide stable results and a good generalization.

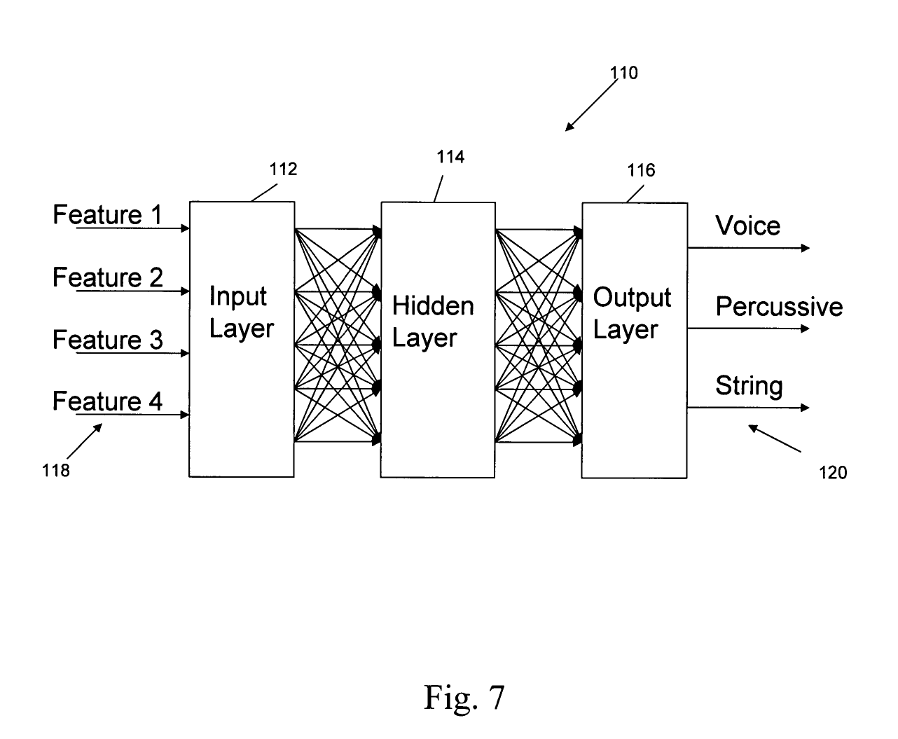

As shown in FIG. 7, a feedforward network 110 includes an input layer 112, one or more hidden layers 114, and an output layer 116. Neurons in the input layer receive a full set of extracted features 118 and respective weights. An offline supervised training algorithm tunes the weights with which the features are passed to each of the neurons. The hidden layer(s) include neurons with nonlinear activation functions. Multiple layers of neurons with nonlinear transfer functions allow the network to learn the nonlinear and linear relationships between input and output signals. The number of neurons in the output layer is equal to the number of types of sources the classifier can recognize. Each of the outputs of the network signals the presence of a certain type of source 120, and the value [0,1] indicates the confidence that the input signal includes a given audio source. If sub-band filtering is employed, the number of output neurons maybe equal to the number of sources multiplied by the number of sub-bands. In this case, the output of a neuron indicates the presence of a particular source in a particular sub-band. The output neurons can be passed on “as is”, thresholded to only retain the values of neurons above a certain level, or threshold to only retain the one most predominant source.

The network should be pre-trained on a set of sufficiently representative signals. For example, for the system capable of recognizing four different recordings containing: male voice, female voice, percussive instruments and string instruments, all these types of the sources should be present in training set in sufficient varieties. It is not necessary to exhaustively present all the possible kinds of the sources due to the generalization ability of the neural network. Each recording should be passed through the feature extraction part of the algorithm. The extracted features are then arbitrarily mixed into two data sets: training and validation. One of the well-known supervised training algorithms is then used to train the network (e.g. such as Levenberg-Marquardt algorithm).

The robustness of the classifier is strongly dependent on the set of extracted features. If the features together differentiate the different sources the classifier will perform well. The implementation of multi-resolution and sub-band filtering to augment the standard audio features presents a much richer feature set to differentiate and properly classify audio sources in the monophonic signal.

In an exemplary embodiment, a 5-3-3 feedforward network architecture (5 neurons on the input layer, 3 neurons in hidden layer, and 3 neurons on the output layer) with tansig (hyperbolic tangent) activator functions at all layers performed well for classification of three types of sources; voice, percussion and string. In the feedforward architecture used, each neuron of the given layer is connected to every neuron of the preceding layer (except for the input layer). Each neuron in the input layer received full set of extracted features. The features presented to the network included multi-resolution tonal components, multi-resolution TNR, and Cepstrum Peak, which were pre-normalized so to fit into [−1:1] range. The first output of the network signaled the presence of voice source in the signal. The second output signaled presence of string instruments. And finally the third output was trained to signal presence of percussive instruments.

At each layer, a ‘tansig’ activator function was used. A computationally-effective formula to compute output of a k^{th} neuron in j^{th} layer is given by:

$${A}_{j , k} = \frac{2}{1 + exp ( - 2 \cdot {\sum }_{i} {W}_{j , k}^{i} \cdot {A}_{j - 1 , i} )} - 1$$

Where: A_{j,k}—output of k^{th} neuron in j^{th} layer;
W_{j,k}ⁱ—i^{th} weight of that neuron (set during training).

For the input layer the formula is:

$${A}_{1 , k} = \frac{2}{1 + exp ( - 2 \cdot {\sum }_{i} {W}_{1 , k}^{i} \cdot {F}_{i} )} - 1$$

Where: Fᵢ—i^{th} feature
W_{l,k}ⁱ—i^{th} weight of that neuron (set during training).

To test a simple classifier, a long audio file was concatenated from three different kinds of audio signals. The blue lines depict the real presence of voice (German speech) 130, percussive instrument (hi-hats) 132, and a string instrument (acoustic guitar) 134. The file is approximately 800 frames in length in which the first 370 frames are voice, the next 100 frames are percussive, and the last 350 frames are string. Sudden dropouts in blue lines corresponds to a periods of silence in input signal. The green lines represent predictions of voice 140, percussive 142 and 144 given by the classifier. The output values have been filtered to reduce noise. The distance of how far the network output is from either 0 or 1 is a measure of how certain the classifier is that the input signal includes that particular audio source.

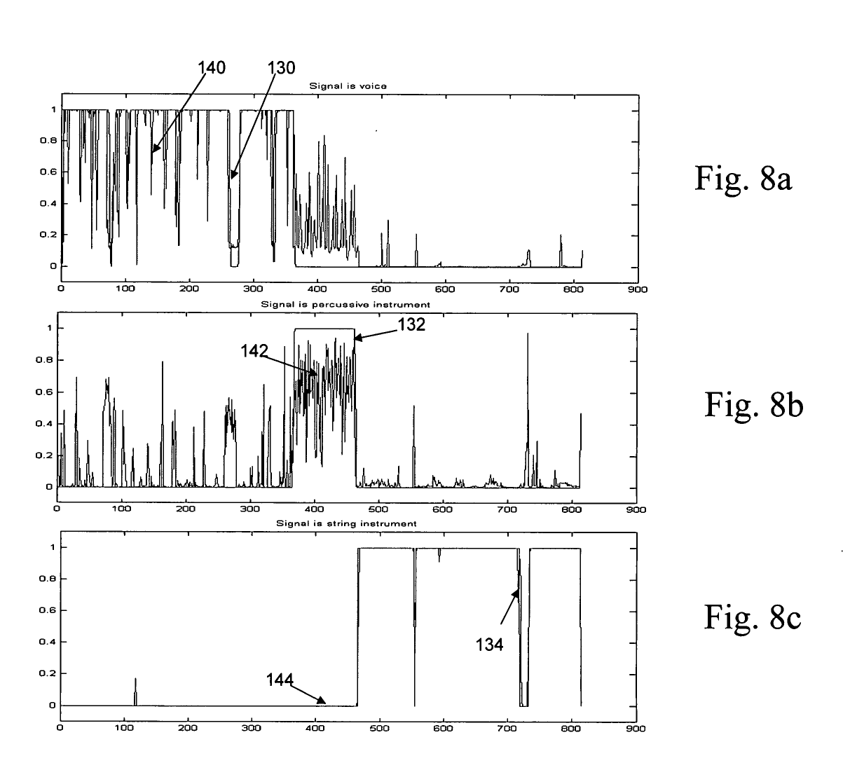

Although the audio file represents a monophonic signal in which none of the audio sources are actually present at the same time, it is adequate and simpler to demonstrate the capability of the classifier. As shown in FIG. 8c, the classifier identified the string instrument with great confidence and no mistakes. As shown in FIGS. 8a and 8b, performance on the voice and percussive signals was satisfactory, although there was some overlap. The use of multi-resolution tonal components would more effectively distinguish between the percussive instruments and voice fragments (in fact, unvoiced fragments of speech).

The classifier outputs can be used as a front-end to create multiple audio channels for a source separation algorithm (e.g., ICA) or as parameters in a post-processing algorithm (e.g. categorize music, track sources, generate audio indexes for the purposes of navigation, re-mixing, security and surveillance, telephone and wireless comm, and teleconferencing).

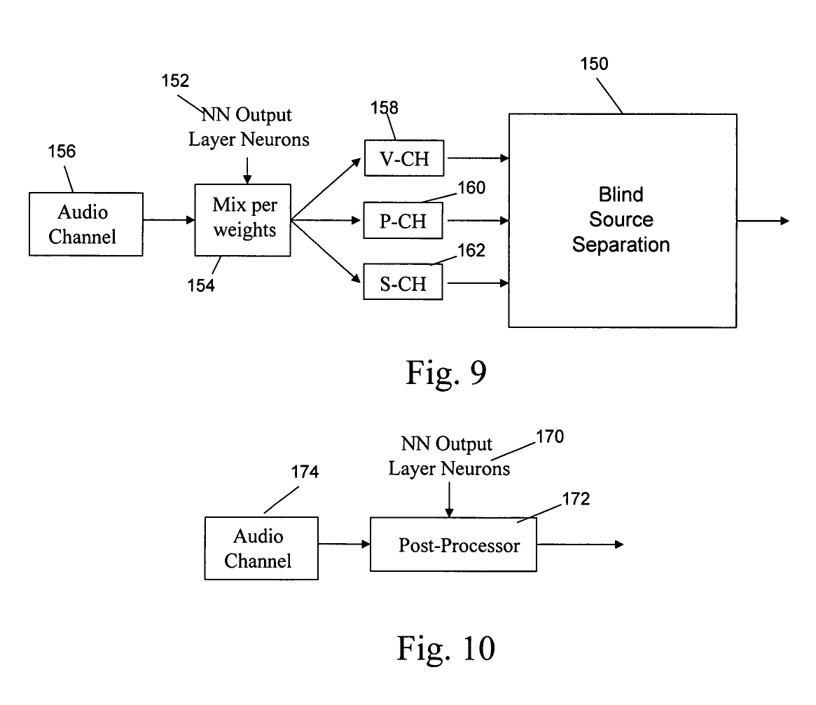

As shown in FIG. 9, the classifier is used as a front-end to a Blind Source Separation (BSS) algorithm 150 such as ICA, which requires as many input channels as sources it is trying to separate. Assume the BSS algorithm wants to separate voice, percussion and string sources from a monophonic signal, which it cannot do. The NN classifier can be configured with output neurons 152 for voice, percussion and string. The neuron values are used as weights to mix 154 each frame of the monophonic audio signal in audio channel 156 into three separate audio channels, one for voice 158, percussion 160 and string 162. The weights may be the actual values of the neurons or thresholded values to identify the one dominant signal per frame. This procedure can be further refined using sub-band filtering and thus produce many more input channels for BSS. The BSS uses powerful algorithms to further refine the initial source separation provided by the NN classifier.

As shown in FIG. 10, the NN output layer neurons 170 can be used in a post-processor 172 that operates on the monophonic audio signal in audio channel 174.

Tracking—algorithm can be applied to individual channels that were obtained with other algorithms (e.g. BSS) that worked on frame-by-frame basis. With the help of the output of the algorithm a linkage of the neighbor frames can be made possible or more stable or simpler.

Audio Identification and Audio Search Engine—extracted patterns of signal types and possibly their durations can be used as an index in database (or as a key for hash table).

Codec—information about type of the signal allow codec to fine-tune a psychoacoustic model, bit allocation or other coding parameters.

Front-end for a source separation—algorithms such as ICA require at least as many input channels as there are sources. Our algorithm may be used to create multiple audio channels from the single channel or to increase number of available individual input channels.

Re-mixing—individual separated channels can be re-mixed back into monophonic representation (or a representation with reduced number of channels) with a post-processing algorithm (like equalizer) in the middle.

Security and surveillance—the algorithm outputs can be used as parameters in a post-processing algorithm to enhance intelligibility of the recorded audio.

Telephone and wireless comm, and teleconferencing—algorithm can be used to separate individual speakers/sources and a post-processing algorithm can assign individual virtual positions in stereo or multichannel environment. A reduced number of channels (or possibly just single channel) will have to be transmitted.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A method for separating audio sources from a monophonic audio signal, comprising:
(a) providing a monophonic audio signal comprising a down-mix of a plurality of unknown audio sources;
(b) separating the audio signal into a sequence of baseline frames;
(c) windowing each frame;
(d) extracting a plurality of audio features from each baseline frame that tend to distinguish the audio sources; and
(e) applying the audio features to a neural network (NN) classifier trained on a representative set of audio sources with said audio features, said neural network classifier outputting at least one measure of an audio source included in each said baseline frame of the monophonic audio signal.

2. The method of claim 1, wherein the plurality of unknown audio sources are selected from a set of musical sources comprising at least voice, string and percussive.

3. The method of claim 1, further comprising:
repeating steps (b) through (d) for a different frame size to extract features at multiple resolutions; and
scaling the extracted audio features at the different resolutions to the baseline frame.

4. The method of claim 3, further comprising applying the scaled features at each resolution to the NN classifier.

5. The method of claim 3, further comprising fusing the scaled features at each resolution into a single feature that is applied to the NN classifier

6. The method of claim 1, further comprising filtering the frames into a plurality of frequency sub-bands and extracting said audio features from said sub-bands.

7. The method of claim 1, further comprising low-pass filtering the classifier outputs.

8. The method of claim 1, wherein one or more audio features are selected from a set comprising tonal components, tone-to-noise ratio (TNR) and Cepstrum peak.

9. The method of claim 8, wherein the tonal components are extracted by:
(f) applying a frequency transform to the windowed signal for each frame;
(g) computing the magnitude of spectral lines in the frequency transform;
(h) estimating a noise-floor;
(i) identifying as tonal components the spectral components that exceed the noise floor by a threshold amount; and
(j) outputting the number of tonal components as the tonal component feature.

10. The method of claim 9, wherein the length of the frequency transform equals the number of audio samples in the frame for a certain time-frequency resolution.

11. The method of claim 10, further comprising:
repeating the steps (f) through (i) for different frame and transform lengths; and
outputting a cumulative number of tonal components at each time-frequency resolution.

12. The method of claim 8, wherein the TNR feature is extracted by:
(k) applying a frequency transform to the windowed signal for each frame;
(l) computing the magnitude of spectral lines in the frequency transform;
(m) estimating a noise-floor;
(n) determining a ratio of the energy of identified tonal components to the noise floor; and
(o) outputting the ratio as the TNR feature.

13. The method of claim 12, wherein the length of the frequency transform equals the number of audio samples in the frame for a certain time-frequency resolution.

14. The method of claim 13, further comprising:
repeating the steps (k) through (n) for different frame and transform lengths; and
averaging the ratios from the different resolutions over a time period equal to the baseline frame.

15. The method of claim 12, wherein the noise floor is estimated by:
(p) applying a low-pass filter over magnitudes of spectral lines,
(q) marking components sufficiently above the filter output,
(r) replacing the marked components with the low-pass filter output,
(s) repeating steps (a) through (c) a number of times, and
(t) outputting the resulting components as the noise floor estimation.

16. The method of claim 1, wherein the Neural Network classifier includes a plurality of output neurons that each indicate the presence of a certain audio source in the monophonic audio signal.

17. The method of claim 16, wherein the value of each output neuron indicates a confidence that the baseline frame includes the certain audio source.

18. The method of claim 1, further comprising using the measure to remix the monophonic audio signal into a plurality of audio channels for the respective audio sources in the representative set.

19. The method of claim 18, wherein the monophonic audio signal is remixed by switching it to the audio channel identified as the most prominent.

20. The method of claim 18, wherein the Neural Network classifier outputs a measure for each of the audio sources in the representative set that indicates a confidence that the frame includes the corresponding audio source, said monophonic audio signal being attenuated by each of said measures and directed to the respective audio channels.

21. The method of claim 18, further comprising processing said plurality of audio channels using a source separation algorithm that requires at least as many input audio channels as audio sources to separate said plurality of audio channels into an equal or lesser plurality of said audio sources.

22. The method of claim 21, wherein said source separation algorithm is based on blind source separation (BSS).

23. The method of claim 1, further comprising passing the monophonic audio signal and the sequence of said measures to a post-processor that uses said measures to augment the post-processing of the monophonic audio signal.

24. A method for separating audio sources from a monophonic audio signal, comprising:
(a) providing a monophonic audio signal comprising a down-mix of a plurality of unknown audio sources;
(b) separating the audio signal into a sequence of baseline frames;
(c) windowing each frame;
(d) extracting a plurality of audio features from each baseline frame that tend to distinguish the audio sources;
(e) repeating steps (b) through (d) with a different frame size to extract features at multiple resolutions;
(f) scaling the extracted audio features at the different resolutions to the baseline frame; and
(g) applying the audio features to a neural network (NN) classifier trained on a representative set of audio sources with said audio features, said neural network classifier having a plurality of output neurons that each signal the presence of a certain audio source in the monophonic audio signal for each baseline frame.

25. An audio source classifier, comprising:
A framer for separating a monophonic audio signal comprising a down-mix of a plurality of unknown audio sources into a sequence of windowed baseline frames;
A feature extractor for extracting a plurality of audio features from each baseline frame that tend to distinguish the audio sources; and
A neural network (NN) classifier trained on a representative set of audio sources with said audio features, said neural network classifier receiving the extracted audio features and outputting at least one measure of an audio source included in each said baseline frame of the monophonic audio signal.

26. The audio source classifier of claim 25, wherein the feature extractor extracts one or more of the audio features at multi time-frequency resolutions.

27. The audio source classifier of claim 25, wherein the NN classifier has a plurality of output neurons that each signal the presence of a certain audio source in the monophonic audio signal for each baseline frame.
